(19) United States
(12) Patent Application Publication
(10) Pub. No.: US 2005/0097385 A1
(43) Pub. Date: May 5, 2005

(54) Method of fault correction for an array of fusible links

(76) Inventors: Adam Jude Ahne, Lexington, KY (US); Donald Fred Croley, Georgetown, KY (US); John Glenn Edelen, Versailles, KY (US); Kristi Maggard Rowe, Richmond, KY (US); Timothy Lowell Strunk, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 10/686,052

(22) Filed: Oct. 15, 2003

(51) Int. Cl. G06F 11/00

(52) U.S. Cl. 714/2

(57) ABSTRACT

A method of fault correction for an array of fusible links includes the steps of storing digital information in a first plurality of fusible links to place the first plurality of fusible links in a first programmed state; storing the digital information in a second plurality of fusible links to place the second plurality of fusible links in a second programmed state; and performing a logic operation to combine the first programmed state with the second programmed state, the logic operation providing an output that is identical to one of the first programmed state and the second programmed state for a respective one of the first plurality of fusible links and the second plurality of fusible links that does not include a faulty bit.

### BACKGROUND OF THE INVENTION

1. Field of the Invention

The present invention relates to improving the robustness of an array of fusible links, and, more particularly, to a method of fault correction for an array of fusible links.

2. Description of the Related Art

In a printing environment, fusible links, also referred to as micro-fuses, are located on a printhead cartridge to store cartridge related information, such as for example, manufacturing information, ink capacity, ink type, cartridge type, cartridge identification number, etc. Such fusible links may be fabricated as a part of a silicon chip, and may be formed on the silicon chip commonly referred to as a printhead chip that includes such components as, for example, ink jetting heater elements. It has been discovered that due to the sealed nature of the silicon chip, a “blown”, i.e., opened, fusible link can potentially reattach itself under certain conditions. In other words, since the fusible link is not vented to the atmosphere, the particles making up the fusible link are still present after the fusible link is blown, and under certain electrical and/or mechanical conditions, e.g., voltage and/or vibration, the gap in the fusible link may be bridged, thereby returning from a blown (opened) state to a non-blown state, which in turn leads to an erroneous representation of data by the faulty fusible link.

What is needed in the art is a method of fault correction for an array of fusible links.

### SUMMARY OF THE INVENTION

The present invention provides fault correction for an array of fusible links, and also provides a sense circuit for reading a fusible link.

The invention, in one form thereof, relates to a method of fault correction for an array of fusible links, including the steps of providing a first plurality of fusible links; providing a second plurality of fusible links; storing digital information in the first plurality of fusible links to place the first plurality of fusible links in a first programmed state; storing the digital information in the second plurality of fusible links to place the second plurality of fusible links in a second programmed state, the first programmed state and the second programmed state being identical in an absence of a faulty bit in one of the first plurality of fusible links and the second plurality of fusible links; and performing a logic operation to combine the first programmed state with the second programmed state, the logic operation providing an output that is identical to one of the first programmed state and the second programmed state for a respective one of the first plurality of fusible links and the second plurality of fusible links that does not include the faulty bit.

In another form thereof, the invention relates to a sense circuit for reading a fusible link. A first transistor defines a read input for receiving a read signal, a first terminal coupled to the fusible link, and a second terminal coupled to an output port. A second transistor has a bias input biased to a voltage reference, has a third terminal coupled to the second terminal of the first transistor, and a fourth terminal coupled to a ground.

In still another form thereof, the invention relates to a printhead including an array of fusible links, the array of fusible links including a first plurality of fusible links and a second plurality of fusible links, the first plurality of fusible links being redundant with respect to the second plurality of fusible links.

An advantage of the present invention is improved robustness of an array of fusible links, such as for example, the fusible links present on an ink jet printhead.

Another advantage of the invention is that a determination of an opened, i.e., blown, fusible link may be made even though the resistance of the fusible link is not infinity, and may, for example, be between 1 k ohms and 30 k ohms.

### BRIEF DESCRIPTION OF THE DRAWINGS

The above-mentioned and other features and advantages of this invention, and the manner of attaining them, will become more apparent and the invention will be better understood by reference to the following description of an embodiment of the invention taken in conjunction with the accompanying drawings, wherein:

FIG. 1 is a diagrammatic representation of a system employing an embodiment of the present invention.

FIG. 2 is diagrammatic representation of a circuit for programming and reading fusible links in accordance with the present invention.

FIG. 3 is a schematic diagram of an embodiment showing a circuit that may be used in performing reading and/or writing with respect to a fusible link.

FIG. 4 is a graph representing the operation of the circuit of FIG. 3.

FIG. 5 is a schematic diagram of another embodiment showing a circuit that may be used in performing reading and/or writing with respect to a fusible link.

FIG. 6 is a graph representing the operation of the circuit of FIG. 5.

FIG. 7 is a flowchart of a method of fault correction for an array of fusible links, in accordance with the present invention.

Corresponding reference characters indicate corresponding parts throughout the several views. The exemplifications set out herein illustrate embodiments of the invention, and such exemplifications are not to be construed as limiting the scope of the invention in any manner.

### DETAILED DESCRIPTION OF THE INVENTION

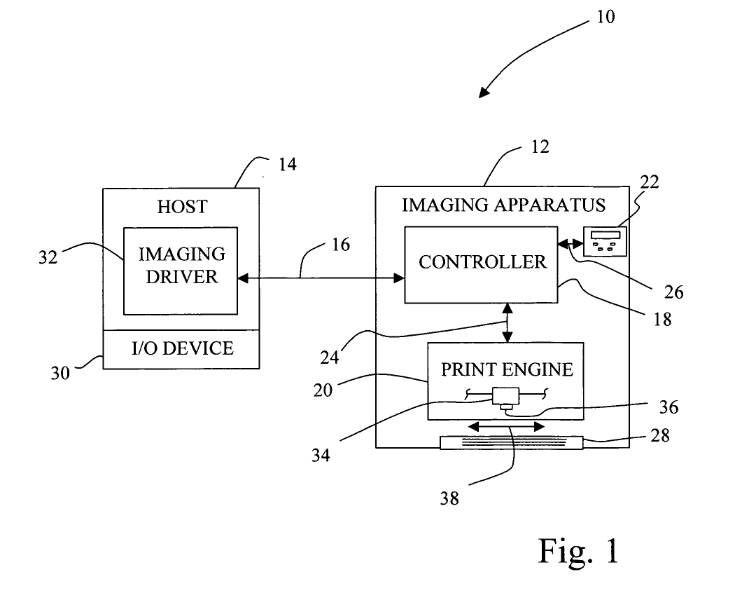

Referring now to the drawings, and particularly to FIG. 1, there is shown a diagrammatic depiction of a system 10 embodying the present invention. System 10 includes an imaging apparatus 12 and a host 14. Imaging apparatus 12 communicates with host 14 via a communications link 16.

Imaging apparatus 12 can be, for example, an ink jet printer and/or copier. Imaging apparatus 12 includes a controller 18, a print engine 20 and a user interface 22.

Controller 18 includes a processor unit and associated memory, and may be formed as an Application Specific Integrated Circuit (ASIC). Controller 18 communicates with print engine 20 via a communications link 24. Controller 18 communicates with user interface 22 via a communications link 26.

Host 14 may be, for example, a personal computer including an input/output (I/O) device 30, such as keyboard and display monitor. Host 14 further includes a processor, input/output (I/O) interfaces, memory, such as RAM, ROM, NVRAM, and a mass data storage device, such as a hard drive, CD-ROM and/or DVD units. During operation, host 14 includes in its memory a software program including program instructions that function as an imaging driver 32, e.g., printer driver software, for imaging apparatus 12. Imaging driver 32 is in communication with controller 18 of imaging apparatus 12 via communications link 16. Imaging driver 32 facilitates communication between imaging apparatus 12 and host 14, and may provide formatted print data to imaging apparatus 12, and more particularly, to print engine 20. Alternatively, however, all or a portion of imaging driver 32 may be located in controller 18 of imaging apparatus 12.

Communications link 16 may be established by a direct cable connection, wireless connection or by a network connection such as for example an Ethernet local area network (LAN). Communications links 24 and 26 may be established, for example, by using standard electrical cabling or bus structures, or by wireless connection.

In the context of the example for imaging apparatus 12 given above, print engine 20 may be, for example, an ink jet print engine configured for forming an image on a print medium 28, such as a sheet of paper, transparency or fabric. Print engine 20 may include, for example, a reciprocating printhead carrier 34 that carries at least one ink jet printhead 36, and may be mechanically and electrically configured to mount, carry and facilitate multiple cartridges, such as a monochrome printhead cartridge and/or one or more color printhead cartridges, each of which including a respective printhead 36. For example, in systems using cyan, magenta, yellow and black inks, printhead carrier 34 would carry four printheads, one printhead for each of cyan, magenta, yellow and black. Printhead carrier 34 is controlled by controller 18 via communication link 24 to move printhead 36 in a reciprocating manner along a bi-directional scan path 38, which is also commonly referred to as a horizontal direction. Printhead 36 is formed, for example, from a silicon substrate and includes typical electrical components, controlled by controller 18, for ejecting ink drops.

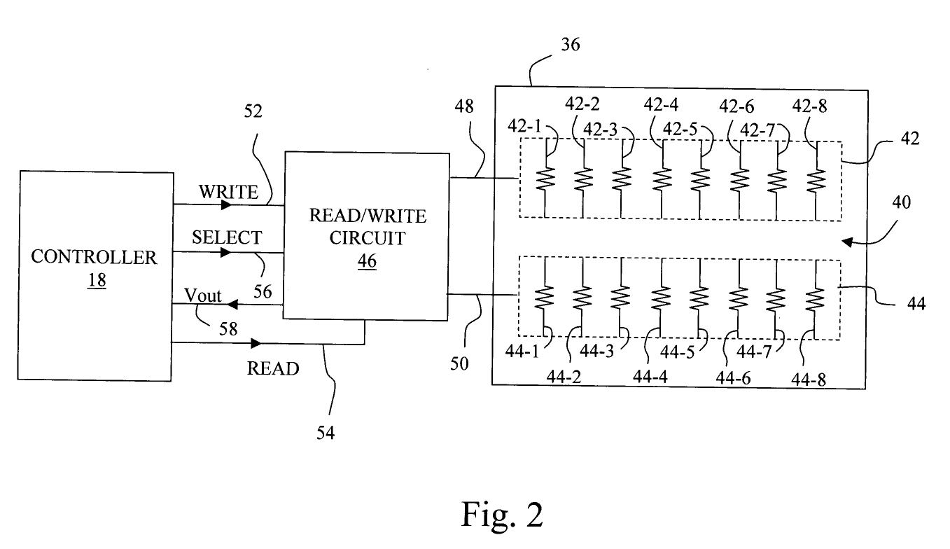

Referring to FIG. 2, printhead 36 includes an array of fusible links 40, including a first plurality of fusible links 42 and a second plurality of fusible links 44. In accordance with the present invention, the first plurality of fusible links 42 and the second plurality of fusible links 44 are redundant with respect to each other. For purposes of illustration, each of the first plurality of fusible links 42 and the second plurality of fusible links 44 contain eight fusible links. However, the concepts of the present invention will apply to any number of fusible links.

In accordance with the present invention, a Read/Write circuit 46 is provided for individually and selectively programming or reading fusible links 42-1, 42-2, 42-3, 42-4, 42-5, 42-6, 42-7 and 42-8 of the first plurality of fusible links 42, and for individually and selectively programming or reading fusible links 44-1, 44-2, 44-3, 44-4, 44-5, 44-6, 44-7 and 44-8 of the second plurality of fusible links 44.

Read/Write circuit 46 is coupled to the first plurality of fusible links 42 via a communications link 48, and is coupled to the second plurality of fusible links 44 via a communications link 50. Communications links 48, 50 may be, for example, an electrical communications bus.

Read/Write circuit 46 is coupled to controller 18 via a communications link 52, a communications link 54, a communications link 56 and a communications link 58. Communications links 52, 54, 56, 58 may be, for example, an electrical communications bus, or electrical cabling. Controller 18 supplies a WRITE signal to Read/Write circuit 46 via communications link 52. Controller 18 supplies a READ signal to Read/Write circuit 46 via communications link 54. Controller 18 supplies a SELECT signal to Read/Write circuit 46 via communications link 56.

The SELECT signal identifies one or more of fusible links 42-1, 42-2, 42-3, 42-4, 42-5, 42-6, 42-7 and 42-8 and one or more of fusible links 44-1, 44-2, 44-3, 44-4, 44-5, 44-6, 44-7 and 44-8 for programming during a WRITE operation, in which each selected fusible link is opened, i.e., blown, based on the WRITE signal supplied by controller 18 to Read/Write circuit 46. Likewise, the SELECT signal identifies one or more of fusible links 42-1, 42-2, 42-3, 42-4, 42-5, 42-6, 42-7 and 42-8 and one or more of fusible links 44-1, 44-2, 44-3, 44-4, 44-5, 44-6, 44-7 and 44-8 for reading during a READ operation, in which the selected fusible link is read based on the READ signal supplied by controller 18 to Read/Write circuit 46. A voltage output Vout representing the fused condition (i.e., closed or opened) of the selected fusible link is supplied to controller 18 from Read/Write circuit 46 via communications link 58 during the Read operation.

It is contemplated that Read/Write circuit 46 may be a separate device, or may be incorporated, for example, into either controller 18 or printhead 36.

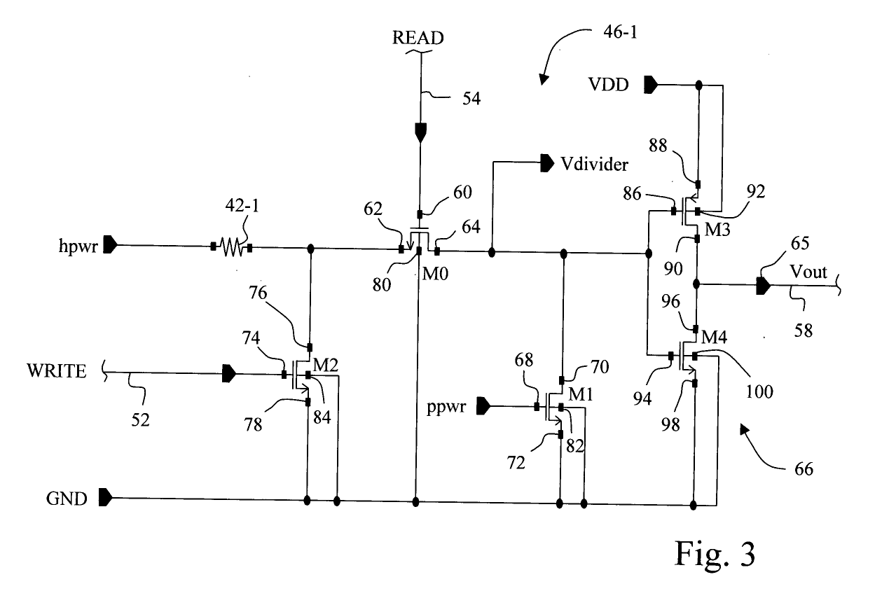

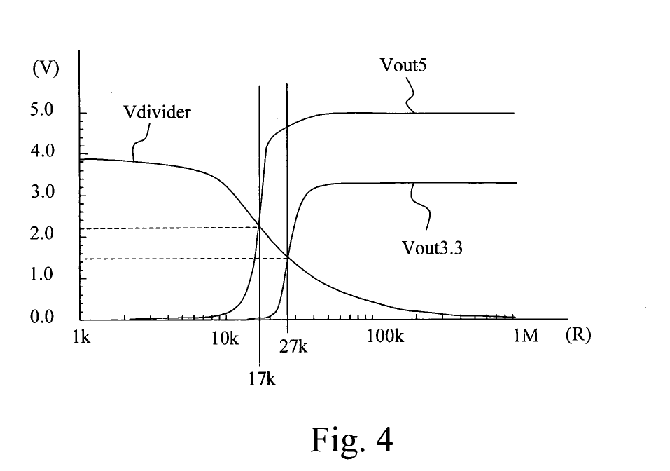

FIG. 3 shows an embodiment of a circuit 46-1, which may be used as a portion of Read/Write circuit 46 in performing reading and/or writing with respect to exemplary fusible link 42-1, as shown. Those skilled in the art will recognize that the circuit of FIG. 3 is easily adapted to read/write each of the fusible links of the array of fusible links 40. However, for ease of understanding, the operation of circuit 46-1 shown in FIG. 3 will be described in relation to fusible link 42-1, and with respect to the graph of FIG. 4.

FIG. 3 includes MOS transistors M0, M1, M2, M3 and M4. As shown, transistors M0, M1, M2 and M4 are NMOS transistors, and transistor M3 is a PMOS transistor. Transistor M0 is used to control a READ operation associated with fusible link 42-1. Transistor M2 is used to control a WRITE operation associated with fusible link 42-1.

Transistor M0 defines a read input 60 for receiving the READ signal, a terminal 62 coupled, e.g., connected, to fusible link 42-1, and a terminal 64 coupled to an output port 65 (Vout) via an inverter circuit 66 made up by transistors M3, M4. Transistor M1 has a bias input 68 biased to a voltage reference ppwr, a terminal 70 coupled to terminal 64 of transistor M0, and a terminal 72 coupled to ground GND. Transistor M2 defines a write input 74 for receiving the WRITE signal, a terminal 76 coupled to fusible link 42-1, and a terminal 78 coupled to ground GND. The body connections 80, 82 and 84 of transistors M0, M1 and M2, respectively, are tied to ground GND. A voltage divider output Vdivider is identified as a reference point and corresponds to terminal 64 of transistor M0, and corresponds to the input to inverter 66.

Inverter circuit 66 is made up by transistors M3, M4, and is coupled between terminal 64 of transistor M0 and output port 65. Transistor M3 defines an input terminal 86 coupled to terminal 64 of transistor M0, a terminal 88 connected to voltage source VDD, a terminal 90 coupled to output port 65, and a body connection 92 connected to voltage source VDD. Transistor M4 defines an input terminal 94 connected to terminal 64 of transistor M0 and to terminal 86 of transistor M3, a terminal 96 coupled to output port 65 and terminal 90 of transistor M3, a terminal 98 coupled to ground GND, and a body connection 100 tied to ground GND.

In one embodiment of the invention, the channel length of transistors M0, M2 and M4 is 1.2 micrometers (μm), the channel length of transistor M1 is 1.7 μm, and the channel length of transistor M3 is 1.9 μm. The voltage reference ppwr may be, for example, set at 7.5 volts, and voltage reference hpwr may be, for example, set at 10.8 volts.

With respect to the circuit 46-1 of FIG. 3, the graph of FIG. 4 plots a change in the voltage Vout at output port 65 with respect a change in the resistance of fusible link 42-1, for each of the conditions where VDD is selected to be 3.3 volts (Vout3.3) and where VDD is selected to be 5 volts (Vout5). As shown, fusible link 42-1 may be determined to be opened when the voltage of the voltage divider Vdivider is equal to Vout, i.e., the switching point. For example, assuming a voltage VDD of 3.3 volts, fusible link 42-1 may be determined to be opened when the resistance of fusible link 42-1 is about 27 k ohms, i.e., with an output voltage (Vout3.3) of about 1.5 volts, and with a read current through fusible link 42-1 of about 630 micro amps (μA). However, by increasing the VDD voltage to 5 volts, fusible link 42-1 may be determined to be opened when the resistance of fusible link 42-1 is about 17 k ohms, i.e., with an output voltage (Vout5) of about 2.25 volts. Thus, depending on the value selected for VDD, in the circuit arrangement of FIG. 3, the output voltage Vout that signifies that fusible link 42-1 is opened may be in a range from about 1 volt to about 2.5 volts, wherein the corresponding resistance of fusible link 42-1, when determined to be opened, is in a corresponding range, for example, of about 15 k ohms to about 30 k ohms.

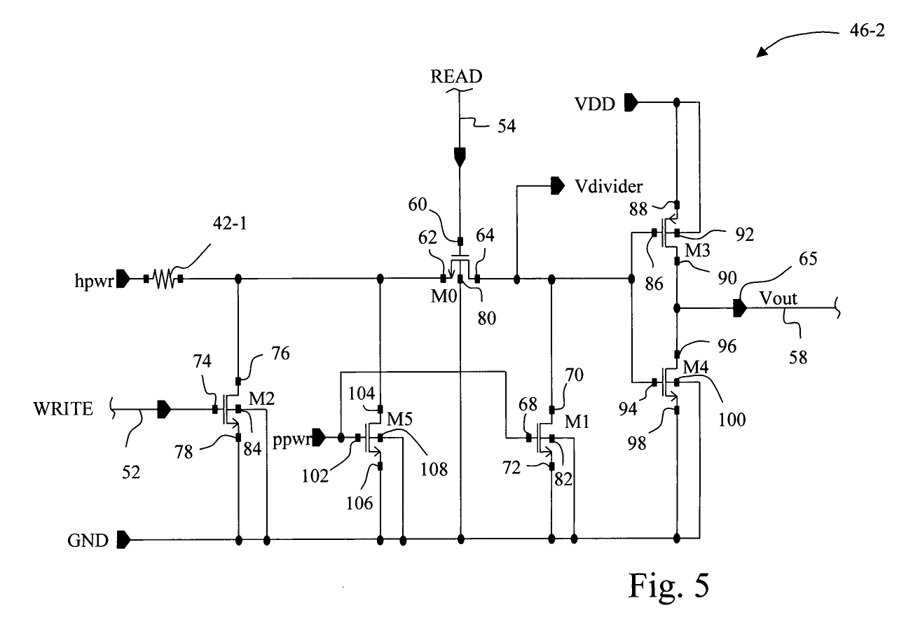

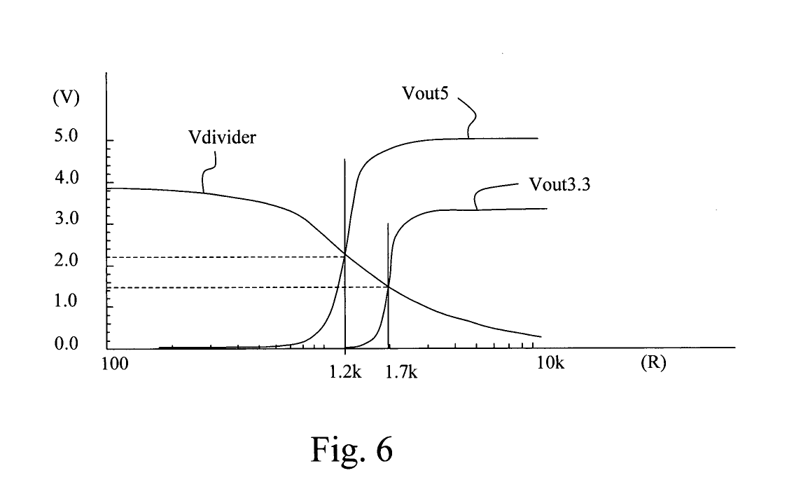

FIG. 5 shows an embodiment of a circuit 46-2, which alternatively may be used as a portion of Read/Write circuit 46 in performing reading and/or writing with respect to exemplary fusible link 42-1, as shown. Those skilled in the art will recognize that the circuit of FIG. 5 is easily adapted to read/write each of the fusible links of the array of fusible links 40. However, for ease of understanding, the operation of circuit 46-2 shown in FIG. 5 will be described in relation to fusible link 42-1, and with respect to the graph of FIG. 6.

Circuit 46-2 shown in FIG. 5 includes MOS transistors M0, M1, M2, M3 and M4 configured as described above with respect to FIG. 3. In addition, however, circuit 46-2 includes a transistor M5 that is used to further reduce the switching point, i.e., the point where the voltage of the voltage divider Vdivider is equal to Vout, which in turn signifies that fusible link 42-1 is opened. Transistor M5 may have a channel length, for example, of about 1.2 μm. Transistor M5 has a bias input 102 biased to voltage reference ppwr, a terminal 104 coupled between fusible link 42-1 and terminal 62 of transistor M0, a terminal 106 coupled to ground GND, and a body connection 108 tied to ground GND.

With respect to the circuit 46-2 of FIG. 5, the graph of FIG. 6 plots a change in the voltage Vout with respect a change in the resistance of fusible link 42-1, for each of the conditions where VDD is selected to be 3.3 volts (Vout3.3) and where VDD is selected to be 5 volts (Vout5). As shown, fusible link 42-1 may be determined to be opened when the voltage of the voltage divider Vdivider is equal to Vout, i.e., the switching point. For example, assuming a voltage VDD of 3.3 volts, fusible link 42-1 may be determined to be opened when the resistance of fusible link 42-1 is about 1.7 k ohms, i.e., with an output voltage (Vout3.3) of about 1.5 volts. The read current through fusible link 42-1 is about 9.6 milliamps (mA), which is less than 10 percent of the write current (about 120 mA) used to open fusible link 42-1.

By increasing the VDD voltage to 5 volts, fusible link 42-1 may be determined to be opened when the resistance of fusible link 42-1 is about 1.2 k ohms, i.e., with an output voltage (Vout5) of about 2.25 volts. Thus, depending on the value selected for VDD, in the circuit arrangement of FIG. 5, the output voltage Vout that signifies that fusible link 42-1 is opened may be in a range, for example, from about 1 volt to about 2.5 volts, wherein the corresponding resistance of fusible link 42-1, when opened, is in a corresponding range of about 1 k ohms to about 2 k ohms.

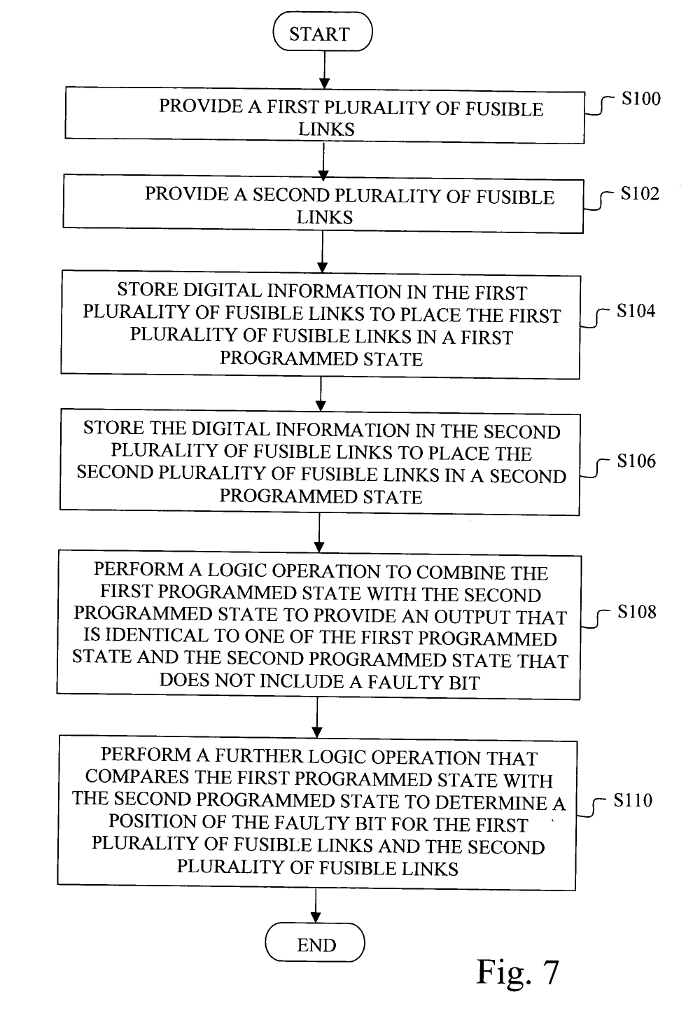

FIG. 7 is a flowchart of a method of fault correction for an array of fusible links, such as the array of fusible links 40, in accordance with the present invention.

At step S100, a first plurality of fusible links, e.g., fusible links 42, is provided. As shown in FIG. 2, fusible links 42 may be formed as a part of a silicon chip, such as printhead 36.

At step S102, a second plurality of fusible links, e.g., fusible links 44, is provided. As shown in FIG. 2, fusible links 42 may be formed as a part of the silicon chip, such as printhead 36.

At step S104, digital information is stored in the fusible links 42 to place the fusible links 42 in a first programmed state. For example, binary information is programmed by controller 18 via Read/Write circuit 46 into fusible links 42 by selectively opening or not opening individual fusible links 42-1, 42-2, 42-3, 42-4, 42-5, 42-6, 42-7, and 42-8 of the plurality of fusible links 42. For example, a binary “0” may be represented by an opened condition, whereas a binary “1” may be represented by a non-opened, i.e., closed, condition. Those skilled in the art will recognize that this binary logic representation may be reversed by inverse logic, if desired.

At step S106, the same digital information is redundantly stored in the second plurality of fusible links 44 to place the second plurality of fusible links 44 in a second programmed state. For example, binary information is programmed by controller 18 via Read/Write circuit 46 into fusible links 44 by selectively opening or not opening individual fusible links 44-1, 44-2, 44-3, 44-4, 44-5, 44-6, 44-7 and 44-8 of the plurality of fusible links 44.

Accordingly, the first programmed state (i.e., the fused condition of fusible links 42) and the second programmed state (i.e., the fused condition of fusible links 44) are identical in an absence of a faulty bit in one of the first plurality of fusible links 42 and the second plurality of fusible links 44.

At step S108, controller 18 performs a logic operation, such as for example a logic AND operation, to combine the first programmed state with the second programmed state. The logic operation provides an output that is identical to one of the first programmed state and the second programmed state for a respective one of the first plurality of fusible links 42 and the second plurality of fusible links 44 that does not include the faulty bit.

For example, assume that each of fusible links 42 and fusible links 44 are programmed to store digital information represented by an original bit sequence 01101110. However, further assume that fusible link 42-1 is faulty, and the bit sequence appears as 11101110 in fusible links 42. By ANDing 01101110 (the contents of fusible links 44) with 11101110 (the contents of fusible links 42), the outcome is 01101110, which corresponds to the original bit sequence, thus correcting for the faulty fusible link 42-1.

Where inverse logic is used, i.e., an opened condition is represented by a binary “1”, a logic OR operation can be used to obtain the desired results.

As indicated above, each of the plurality of fusible links 42 and the plurality of fusible links 44 have a common plurality of bit positions, e.g., 1 through 8. In step S108, if each of the plurality of fusible links 42 and the plurality of fusible links 44 include at least one faulty bit, the logic operation provides an output that is identical to the digital information, so long as a bit position of a first faulty bit in the plurality of fusible links 42 does not correspond to a bit position of a second faulty bit in the plurality of fusible links 44.

For example, assume that each of fusible links 42 and fusible links 44 are programmed to store digital information represented by the original bit sequence 01101110. However, further assume that fusible link 42-1 is faulty, and the bit sequence appears as 11101110 in fusible links 42. Further assume that fusible link 44-4 is faulty, and the bit sequence appears as 01111110 in fusible links 44. By ANDing 01111110 (the contents of fusible links 44) with 11101110 (the contents of fusible links 42), the outcome is 01101110, which corresponds to the original bit sequence, thus correcting for the faulty fusible link 42-1 and the faulty fusible link 44-4.

At step S110, a determination of which bit position is faulty in the array of fusible links 40, i.e., fusible links 42 and fusible links 44, may be made by performing a further logic operation, such as for example an exclusive-OR (XOR) operation, such that by comparing the first programmed state with the second programmed state, any bits that are not identical will show up as a binary “1”. In the example give above, by XORing 01101110 (contents of fusible links 44) with 11101110 (contents of fusible links 42), the outcome is 1000000, thus indicating that the first binary bit position in the plurality of fusible links 42, 44 is faulty, i.e., that one of fusible link 42-1 and fusible link 44-1 is faulty. A threshold number of faulty bits may be set at which the array of fusible links 40 is deemed to be unusable. For example, the threshold may be set at two, such that if more than one faulty bit is detected, then the array of fusible links 40 is deemed unusable.

While this invention has been described with respect to certain embodiments, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

1. A method of fault correction for an array of fusible links, comprising the steps of:
providing a first plurality of fusible links;
providing a second plurality of fusible links;
storing digital information in said first plurality of fusible links to place said first plurality of fusible links in a first programmed state;
storing said digital information in said second plurality of fusible links to place said second plurality of fusible links in a second programmed state, said first programmed state and said second programmed state being identical in an absence of a faulty bit in one of said first plurality of fusible links and said second plurality of fusible links; and
performing a logic operation to combine said first programmed state with said second programmed state, said logic operation providing an output that is identical to one of said first programmed state and said second programmed state for a respective one of said first plurality of fusible links and said second plurality of fusible links that does not include said faulty bit.

2. The method of claim 1, wherein said logic operation is one of an AND operation and an OR operation.

3. The method of claim 1, comprising the step of performing a further logic operation that compares said first programmed state with said second programmed state to determine a position of a faulty bit for said first plurality of fusible links and said second plurality of fusible links.

4. The method of claim 3, wherein said further logic operation is an exclusive-OR operation.

5. The method of claim 3, wherein a threshold is set that identifies a maximum number of bits that can be faulty before said array of fusible links is deemed unusable.

6. The method of claim 1, further comprising the step of providing a circuit which determines that at least one fusible link of said first plurality of fusible links and said second plurality of fusible links has been opened when said at least one fusible link has a resistance in a range of about 1 k ohms to about 2 k ohms.

7. The method of claim 1, further comprising the step of providing a circuit which determines that at least one fusible link of said first plurality of fusible links and said second plurality of fusible links has been opened when said at least one fusible link has a resistance in a range of about 1 k ohms to about 30 k ohms.

8. The method of claim 1, further comprising the step of providing a circuit which determines that at least one fusible link of said first plurality of fusible links and said second plurality of fusible links has been opened when said at least one fusible link has a resistance of at least about 1 k ohms.

9. The method of claim 1, further comprising the step of providing a circuit which determines that a fusible link has been opened when a read current through said fusible link is about ten percent or less of a write current used to open said fusible link.

10. The method of claim 1, said method being implemented in at least one of an ink jet printhead and an ink jet printer.

11. The method of claim 1, each of said first plurality of fusible links and said second plurality of fusible links having a common plurality of bit positions, wherein in said performing step if each of said first plurality of fusible links and said second plurality of fusible links include at least one faulty bit, said logic operation providing an output that is identical to said digital information, so long as a bit position of a first faulty bit in said first plurality of fusible links does not correspond to a bit position of a second faulty bit in said second plurality of fusible links.

12. A sense circuit for reading a fusible link, comprising:
a first transistor defining a read input for receiving a read signal, a first terminal coupled to said fusible link, and a second terminal coupled to an output port; and
a second transistor having a bias input biased to a voltage reference, having a third terminal coupled to said second terminal of said first transistor, and a fourth terminal coupled to a ground.

13. The sense circuit of claim 12, further comprising an inverter circuit coupled between said second terminal of said first transistor and said output port.

14. The sense circuit of claim 12, wherein an output voltage at said output port in a range of about 1 volt to about 2.5 volts signifies that said fusible link is opened.

15. The sense circuit of claim 12, wherein an output voltage at said output port of about 1.5 volts signifies that said fusible link is opened.

16. The sense circuit of claim 12, wherein an output voltage at said output port indicates that said fusible link is opened when said fusible link has a resistance in a range of about 1 k ohms to about 2 k ohms.

17. The sense circuit of claim 12, wherein an output voltage at said output port indicates that said fusible link is opened when said fusible link has a resistance in a range of about 15 k ohms to about 30 k ohms.

18. The sense circuit of claim 12, wherein an output voltage at said output port indicates that said fusible link is opened when said fusible link has a resistance of about 1 k ohms.

19. The sense circuit of claim 12, wherein an output voltage at said output port indicates that said fusible link is opened when said fusible link has a resistance of about 2 k ohms.

20. The sense circuit of claim 12, wherein an output voltage at said output port indicates that said fusible link is opened when said fusible link has a resistance of about 17 k ohms.

21. The sense circuit of claim 12, wherein an output voltage at said output port indicates that said fusible link is opened when said fusible link has a resistance of about 27 k ohms.

22. The sense circuit of claim 12, further comprising a third transistor having an input terminal coupled to said voltage reference, having a fifth terminal coupled between said fusible link and said first terminal of said first transistor, and having a sixth terminal coupled to ground.

23. The sense circuit of claim 12, said sense circuit being incorporated in at least one of an ink jet printhead and an ink jet printer.

24. A printhead comprising an array of fusible links, said array of fusible links including a first plurality of fusible links and a second plurality of fusible links, said first plurality of fusible links being redundant with respect to said second plurality of fusible links.

25. The printhead of claim 24, further comprising a circuit for programming digital information into said array of fusible links.

26. The printhead of claim 24, further comprising a circuit for reading digital information from said array of fusible links.
